(19) United States
(12) Patent Application Publication
(10) Pub. No.: US 2004/0262988 A1
(43) Pub. Date: Dec. 30, 2004

(54) Electric triggering device for control elements and method for triggering control elements

(76) Inventors: Jens Kolarsky, Gerlingen (DE); Georg Sebastian, Markgroeningen (DE); Andreas Schmidtlein, Tamm (DE)

Correspondence Address: KENYON & KENYON, ONE BROADWAY, NEW YORK, NY, 10004, US

(21) Appl. No.: 10/836,723

(22) Filed: Apr. 30, 2004

(30) Foreign Application Priority Data
Apr. 30, 2003 (DE) 103 20 521.7

(51) Int. Cl. B60T 13/66

(52) U.S. Cl. 303/20

(57) ABSTRACT

An electronic control device for control elements, in particular in a motor vehicle, a plurality of control elements being electrically triggered on the triggering side, the triggering by the control of at least one of the control elements with respect to at least one of the other control elements or with respect to at least one group of other control elements being asynchronous as to time; and a method for triggering control elements.

### FIELD OF THE INVENTION

The present invention relates to an electric triggering device for control elements, in particular in a motor vehicle, a plurality of control elements being electrically triggered on the triggering side; it also relates to a method for triggering control elements.

### BACKGROUND INFORMATION

Such an electric triggering device for triggering control elements is conventional. It is used in a brake system of a motor vehicle, for instance. The triggering of the control elements, which are designed as regulating and switching valves, is implemented in a synchronous manner at a pulse-width modulated (PWM) frequency of 4 kHz, for instance. There is a change in the current flow through the valve coils at this frequency, which leads to corresponding starting currents and noise development in moveable parts of the switching valves that are acted upon by the forces of the magnetic fields.

### SUMMARY

In accordance with an example embodiment of the present invention, the starting-current spike and/or the noise development may be reduced by the temporally asynchronous triggering of at least one of the control elements with respect to another control element or a group of other control elements. This is due to the fact that, because of the temporal offset of the triggering procedure, no additive superpositioning of all parameters takes place, but a temporal offset is present instead which, overall, leads to the reduction of the involved variables up to the partial mutual cancellation. In this way, the starting-current spike is reduced, which also results in better electromagnetic compatibility (EMV). Overall, the noise amplitudes are therefore no longer superposed in an additive manner at the same time. This also applies to the current spikes during the switching of the solenoid valves. As a result of an example embodiment of the present invention, additional circuit elements such as capacitors of the switching valves, which are used to suppress EMC-interference by the current spikes, may be configured for lower power losses, so that the overall use is reduced. Since at least one of the control elements is switched asynchronously with respect to at least one other control element, the following options may result: One control element is switched asynchronously with respect to another control element, or one control element is switched asynchronously with respect to a group of other control elements, or a group of control elements is switched asynchronously with respect to another control element, or a group of control elements is switched asynchronously with respect to a group of other control elements. Of course, it is within the scope of the present invention if not only two control elements and/or groups of control elements but more than two are present.

According to a further development of the present invention, it is provided that the control element be a solenoid valve. The solenoid valve may preferably be used in a brake circuit of a motor vehicle.

The triggering of the control elements is preferably implemented by means of at least one pulse-width modulated triggering. The pulse width determines the individual triggering instant for energizing or de-energizing the corresponding solenoid valve or the group of corresponding solenoid valves. The frequency of the pulse-width modulated triggering is selected as a function of the utilized control elements and—as mentioned before—amounts to 4 kHz, for instance.

A further development of the present invention provides that the asynchronous triggering occur via fixedly predefined phase displacements of the trigger signals. As an alternative, it is also possible that the phase displacements are not fixedly predefined, but are chosen with the aid of a random-number generator.

Furthermore, it may be advantageous if the phase displacement in the triggering is a function of certain parameters of the device according to the present invention and/or the motor vehicle. For instance, the type of motor vehicle and/or state variables of the motor vehicle may be utilized as parameters. At high driving speeds, a different phase displacement may be implemented than at lower driving speeds, so that the phase displacement thus is a function of the parameter of the driving speed.

### BRIEF DESCRIPTION OF THE DRAWINGS

FIG. 1 shows an electric triggering device having two control elements and their trigger signals.

FIG. 2 shows the conventional in-phase superpositioning of two signals.

FIG. 3 shows two signals having an approximately 75° phase displacement and their superpositioning.

FIG. 4 shows two signals having a 180° phase displacement and their superpositioning.

FIG. 5 shows a comparison of the power losses without phase displacement and with a 180° phase displacement.

### DETAILED DESCRIPTION OF EXAMPLE EMBODIMENTS

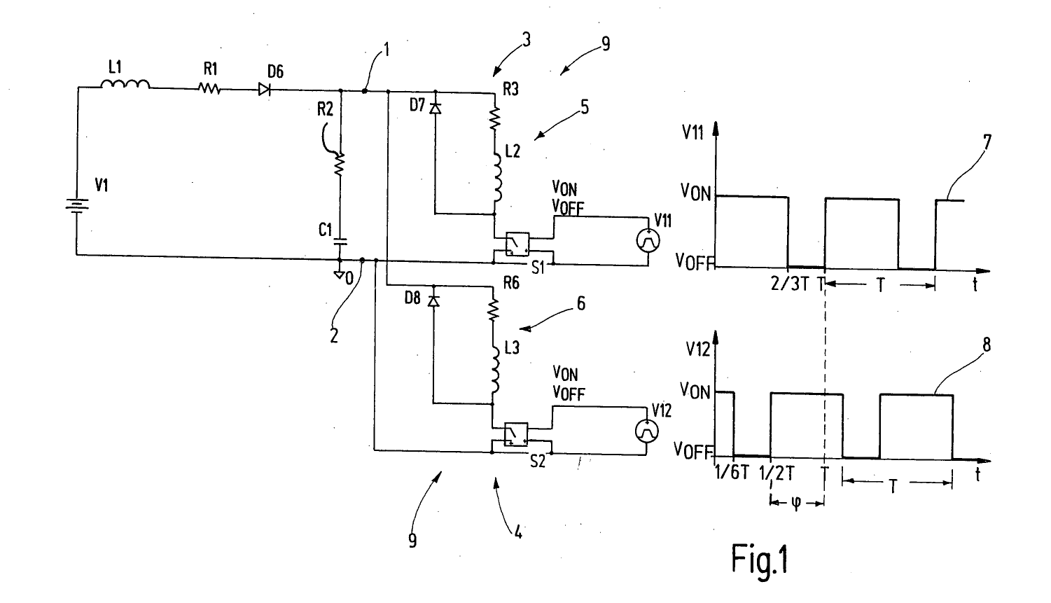

FIG. 1 shows an electrical structure and its triggering in accordance with an example embodiment of the present invention. V1 is the voltage source of the shown configuration, which may be embodied as accumulator or as fuel cell, for instance. The electrical network by which the supply voltage is transmitted in the required form to the loads is represented as a substitute circuit diagram by inductor L1, resistors R1 and R2, capacitor C1 and diode D6. The supply voltage resulting from the network is then applied between terminals 1 and 2. In this exemplary embodiment, control elements 9, in this case embodied as first solenoid valve 3 and second solenoid valve 4, are connected in parallel to terminals 1 and 2. Each solenoid valve has an impedance 5 or 6, which is symbolically represented as resistor R3 or R6 and as inductor L2 or L3, respectively. Furthermore, solenoid valves 3 and 4 have a damping diode D7 and D8, respectively. Solenoid valves 3 and 4 are energized or de-energized by means of an electronic switch S1 and S2, for instance semiconductor switches, the switching behavior of switches S1 and S2 being controlled by control voltages V11 and V12, respectively. This makes it clear that solenoid valves 3 and 4 are connected to a joint operating voltage, but that the operating state of the solenoid valves may be controlled independently of one another by means of control voltages V11 and V12.

The asynchronous triggering of solenoid valves 3 and 4 according to the present invention is shown by way of example by V11-signal characteristic 7 and V12 signal characteristic 8. The signals are generated by an electronic triggering device (not shown) and transmitted to the individual switches S1 and S2 by means of electrical connections. At instant t=0, signal characteristic 7 shows an increase in the level from VOFF to VON. The signal remains at level VON until instant t=2/3T and then returns to level VOFF before rising again to level VON at instant t=T, whereupon the described sequence is repeated. Using this signal, solenoid valve 3 is kept in a controlled partial opening state, by which the transmission of a certain pressure or the flow-through of a desired fluid quantity is effected.

V12 signal characteristic 8 has the same signal sequence as V11 signal characteristic 7. However, a temporal offset, represented by phase displacement φ, has been selected. The comparison of V11 signal characteristic 7 with V12 signal characteristic 8 discloses that the switching instants are asynchronous. This means that the moveable parts of solenoid valves 3 and 4 are now actuated at different instants, so that a direct superpositioning of current spikes and/or noise development is effectively avoided.

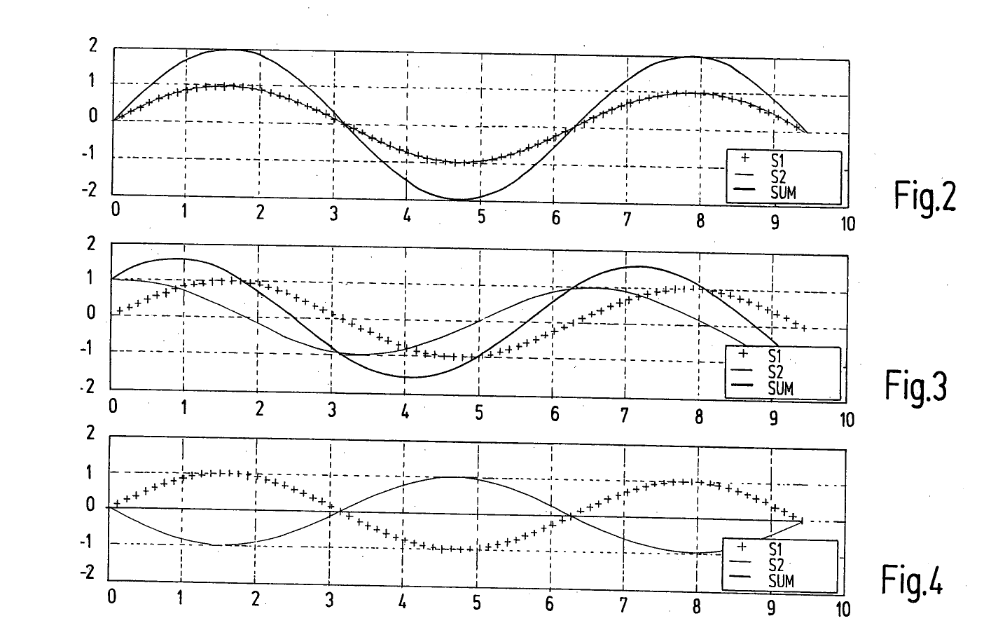

FIGS. 2, 3 and 4, by way of example, show the result that comes about from the superpositioning of two equifrequent, sinusoidal signals having the same amplitude at different phase displacements. This is highly significant since, as is known, square wave signals such as V11 signal characteristic 7 or V12 signal characteristic 8 may be completely broken down into individual sinusoidal signals.

FIG. 2 shows equifrequent signals S1 and S2, which have the same amplitude, having the value 1, and no mutual phase displacement. The addition of signals S2 and S2 results in summation signal SUM, which, given the same frequency and the same phase, has double the amplitude, namely the value 2. This in-phase superpositioning is shown in the related art and may be avoided according to the present invention.

FIG. 3 shows the same signals S1 and S2 which, however, are mutually displaced in their phase by approximately 75°.

Compared to the summation signal of FIG. 2, summation signal SUM of FIG. 3 has a reduced amplitude at the same frequency. In the case of sound waves this means that, while an amplification with respect to the individual signal S1 or S2 takes place, this amplification is substantially less than in the in-phase addition shown in FIG. 2.

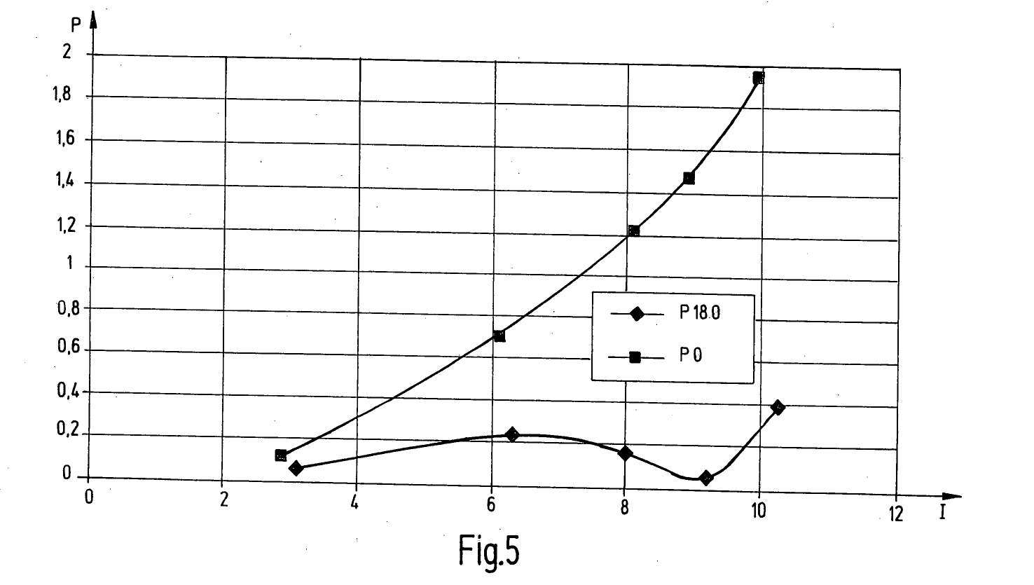

FIG. 4 shows an ideal case of a complete cancellation of the summation signal at a phase displacement of 180°. Using conventional methods (such as a frequency analysis by means of a Fourier transformation), it is possible to determine the frequencies whose amplitude reduction and/or cancellation is desired, which then allows the greatest possible cancellation with the aid of a suitable phase displacement of V11 signal characteristic 7 and V12 signal characteristic 8.

FIG. 5 shows power loss P occurring in the circuit as a function of current I, which flows through the solenoid valves on the way from terminal 1 to terminal 2. If no phase displacement takes place and the current is increased, the known increase PO of the power loss occurs. In contrast, when a phase displacement by 180° takes place and the current increases, characteristic P180 of the power loss remains far below the power losses that occurs without phase displacement. It is even shown in this example that the power loss is at a minimum at a current value of 9 due to optimal cancellation effects.

It is understood that other control elements may be utilized as well and that a plurality of control elements, in particular control elements interconnected into groups, may be operated in an asynchronous manner without leaving the scope of the present invention.

What is claimed is:

1. An electronic control device for control element in a motor vehicle, comprising:
a device configured to electrically trigger with trigger signals a plurality of control elements on a triggering side, wherein at least one of the control elements is temporally asynchronous triggered with respect to one of: i) at least one of the other control elements, or ii) at least one group of the other control elements.

2. The control device as recited in claim 1, wherein the control elements are solenoid valves.

3. The control device as recited in claim 2, wherein the solenoid valves are part of a brake circuit of the motor vehicle.

4. The control device as recited in claim 1, wherein the device includes a pulse-width modulated control device.

5. The control device as recited in claim 1, wherein the device is configured to asynchronously trigger the control elements by at least one fixedly predefined phase displacement of the trigger signals.

6. The control device as recited in claim 1, wherein the device is configured to asynchronously trigger the control element by at least one phase displacement of the trigger signals generated by a random-number generator.

7. The control device as recited in claim 5, wherein the phase displacement of the trigger signals is determined by at least one of: i) a type of the motor vehicle, and ii) at least one state variable of the motor vehicle.

8. The control device as recited in claim 7, wherein the phase displacement of the trigger signals is determined by the at least one state variable, the state vehicle describing at least one of: i) a state of a temperature of at least one assemble of the motor vehicle, and ii) a vehicle speed.

9. A method for the electrical triggering of control elements in a motor vehicle, comprising:
electrically triggering a plurality of control elements on a triggering side, wherein the triggering of at least one of the control elements with respect to one of: i) at least one of the other control elements, or ii) at least one group of other control elements, is implemented asynchronously as to time.
